(19) United States
(12) Patent Application Publication
(10) Pub. No.: US 2007/0246481 A1
(43) Pub. Date: Oct. 25, 2007

(54) Trigger Sprayer Shroud Which Communicates Information

(76) Inventor: Steve L. Sweeton, Lake Winnebago, MO (US)

Correspondence Address: GORDON & JACOBSON, P.C., 60 LONG RIDGE ROAD, SUITE 407, STAMFORD, CT, 06902, US

(21) Appl. No.: 11/379,906

(22) Filed: Apr. 24, 2006

(51) Int. Cl. B05B 11/00; B67D 5/40

(52) U.S. Cl. 222/78; 222/383.1

(57) ABSTRACT

A trigger sprayer has a shroud at least a portion of which is configured to communicate information about the liquid in the bottle to which the sprayer is attached. The shroud is provided with a shape and/or texture, preferably in conjunction with a color, which suggests a quality of the liquid such as its intended use, the identity of its manufacturer, its scent, etc.

### BACKGROUND OF THE INVENTION

1. Field of the Invention

This invention relates broadly to liquid dispensers. More particularly, this invention relates to shrouds for trigger sprayers.

2. State of the Art

Trigger dispensers are ubiquitous in most American homes. They are supplied on plastic bottles which are used to contain and dispense many different kinds of household liquids such as cleaning liquids, scenting liquids, garden liquids, car care liquids, etc. Typically these dispensers include a pump coupled to a trigger and covered with a shroud. Inside the shroud the pump is coupled to an inlet tube and an outlet tube. A rotatable bottle coupling is coupled to the dispenser surrounding the inlet tube and a nozzle is coupled to the dispenser and the outlet tube. Trigger dispensers are available in many different configurations with shrouds having different shapes and colors. The differences among all of the known shrouds are either ergonomic or simply ornamental. However, most of the sprayer shrouds are not distinctive and do not provide any information about the liquid contained in the bottle to which the sprayer is attached.

Frequently consumers have difficulty in locating a particular household liquid because the containers and trigger dispensers are non-distinct. Unless the bottle labels are clearly visible, they all look substantially the same. While this may occur while the consumer is shopping, it most often occurs after the product has been purchased and is stored with other similar products in a dark area, such as under the kitchen sink or in a closet. While manufacturers may attempt to create a decorative look for trigger sprayers used on their products, it would be rare for a consumer to associate the design of a particular trigger sprayer with a particular manufacturer.

### SUMMARY OF THE INVENTION

It therefore is an object of the invention to provide a trigger sprayer shroud which conveys information.

It is another object of the invention to provide a trigger sprayer shroud which conveys information about the liquid in the bottle attached in the sprayer.

It is a further object of the invention to provide a trigger sprayer shroud which permits a consumer to quickly locate a particular type of household liquid.

It is also an object of the invention to provide a shroud which is easily adapted to communicate different information.

In accord with these objects, which will be discussed in detail below, a trigger sprayer shroud according to the invention. In a preferred embodiment, the trigger sprayer shroud has two parts, an upper part and a lower part. The lower part is adapted to hold the pump and trigger assembly, the bottle coupling and the nozzle. The upper part is essentially a canopy and many different style upper parts can be made to fit together with the lower part. According to the preferred embodiment of the invention, the upper part is formed to have a shape or texture, preferably in combination with one or more colors which conveys some information about the liquid in the bottle to which the trigger sprayer is intended to be attached. The information can be, for example, a suggestion of the intended use for the liquid, an indication about some characteristic of the liquid or an indication about the source of the liquid. Intended use can be conveyed, for example, by providing the shroud with the texture of a tire tread and coloring it black and white. This would indicate that the liquid is the bottle to which the sprayer is attached is an automobile tire cleaner. Another example is to make the shroud shaped to look like an automobile. This could indicate that the sprayer is attached to a bottle of car wax. An example of indicating a characteristic of the liquid is to give the shroud the color and texture of an orange, lemon or a lime to indicate the scent of the liquid. An example of indicating the source is to make the shroud green with the shape and/or texture of a turtle shell. This would indicate that the liquid in the container is a product of TurtleWax®.

Additional objects and advantages of the invention will become apparent to those skilled in the art upon reference to the detailed description taken in conjunction with the provided figures.

### BRIEF DESCRIPTION OF THE DRAWINGS

FIG. 1 is an exploded side elevation view of a sprayer having a two part shroud which does not convey any information;

FIG. 2 is a side elevation view of the sprayer of FIG. 1 with the shroud assembled;

FIG. 3 is a side elevation view of a sprayer having a shroud with the upper part having the color and texture of an automobile tire;

FIG. 4 is a rear elevation view of the sprayer of FIG. 3;

FIG. 5 is a side elevation view of a sprayer having a shroud with the upper part having the shape of an automobile;

FIG. 6 is a rear elevation view of the sprayer of FIG. 5;

FIG. 7 is a side elevation view of a sprayer having a shroud with a portion of the upper part portraying an orange slice;

FIG. 8 is a rear elevation view of the sprayer of FIG. 7;

FIG. 9 is a side elevation view of a sprayer having a shroud with the upper part having the shape of a turtle;

FIG. 10 is a rear elevation view of the sprayer of FIG. 9;

FIG. 11 is a side elevation view of a sprayer having a shroud having an upper part having the color and texture of a turtle shell; and

FIG. 12 is a rear elevation view of the shroud of FIG. 11.

### DETAILED DESCRIPTION OF THE PREFERRED EMBODIMENTS

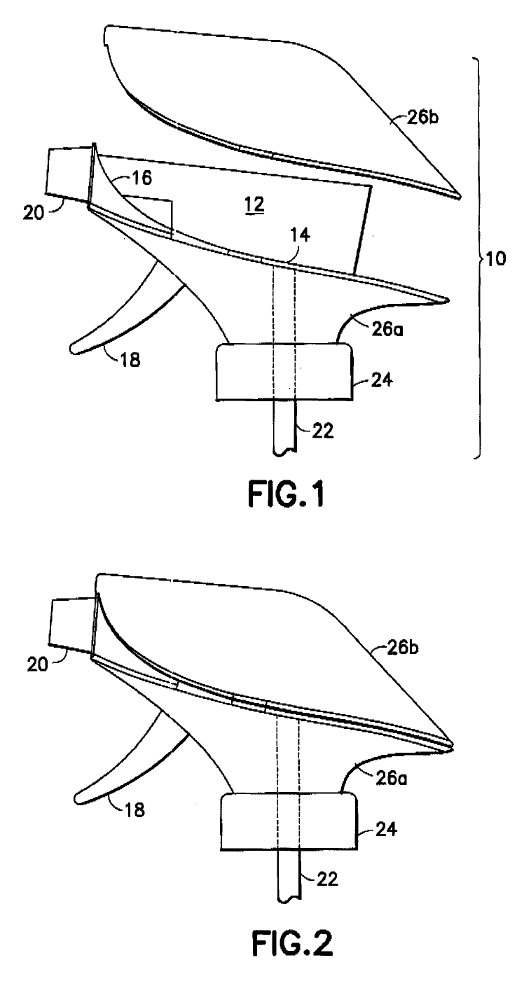

Turning now to FIGS. 1 and 2, a trigger sprayer 10 according to the invention includes a pump 12 having an inlet 14 and an outlet 16 and a trigger 18 operatively coupled to the pump 12. A nozzle 20 is coupled to the outlet 16 of the pump and a tube 22 is coupled to the inlet 14. A bottle coupling 24 surrounds the tube 22 and is designed to couple to a bottle of household liquid. As illustrated and as is presently preferred, a shroud having two parts 26a and 26b houses the pump 12. The lower part 26a of the shroud is coupled to the pump 12, the nozzle 20, and the coupling 24 with the trigger 18 and the tube 22 extending through openings in the lower shroud part 26a. The upper shroud part 26b attaches to the lower part 26a and covers the top of the pump as shown in FIG. 2.

The upper part 26b is essentially a canopy and fits together with the lower part 26a. Both the upper part 26b and lower part 26a can be any of many styles. According to the presently preferred embodiment, the upper part 26b is formed to have a shape or texture, preferably in combination with one or more colors which conveys some information about the liquid in the bottle to which the trigger sprayer is or is going to be attached. The information can be, for example, a suggestion of the intended use for the liquid, an indication about some characteristic of the liquid, or an indication about the source of the liquid.

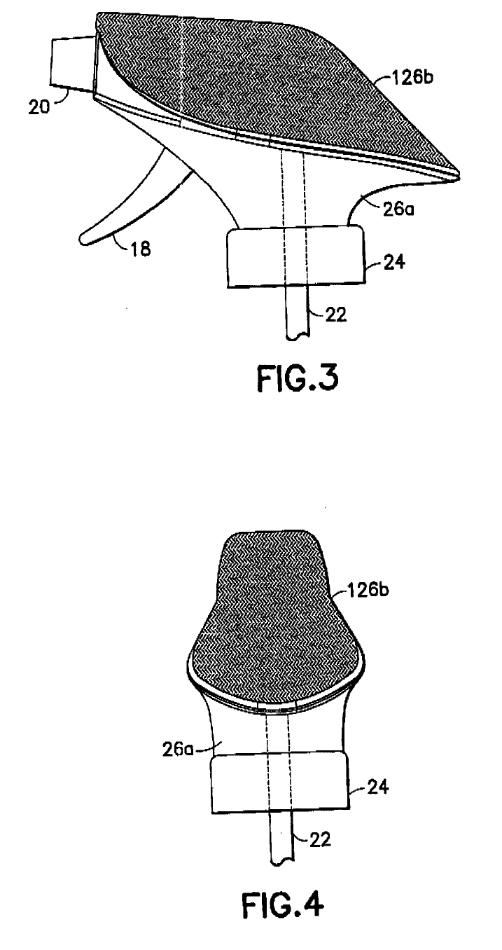

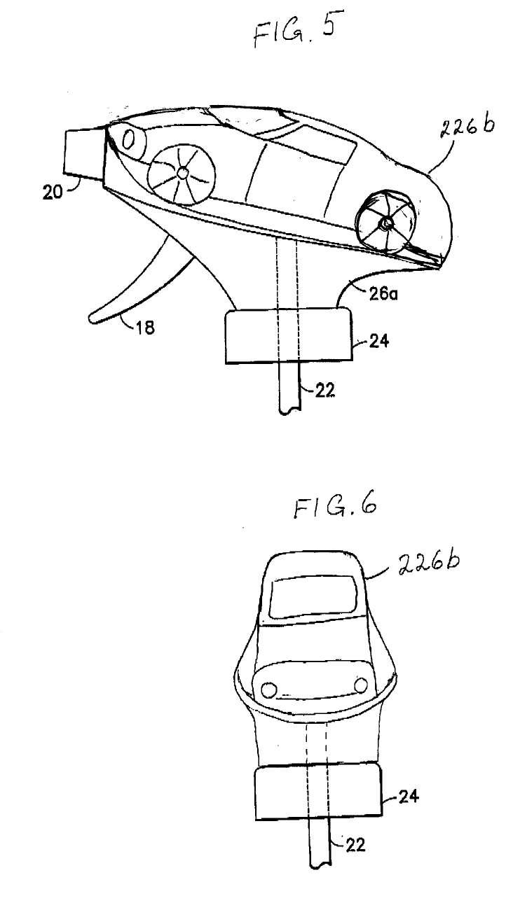

Referring now to FIGS. 3 and 4, an upper shroud part 126b is provided on a sprayer having a trigger 18, nozzle 20, inlet tube 22, cap 24, and lower shroud part 26a, with the texture and color of the upper shroud part 126b indicative of an automobile tire, thereby indicating that the liquid in the bottle (not shown) to which the sprayer is attached is for cleaning automobile tires. Though not shown in the figures, the upper shroud part 126b could also be shaped like a portion of an automobile tire. Another example of indicating intended use is shown in FIGS. 5 and 6.

Turning now to FIGS. 5 and 6, where like numbers indicate like parts, the upper shroud part 226b is shaped and colored to look like an automobile. The upper shroud part is used to indicate that the bottle contains a car product such as car wax, car polish or car cleaner. FIGS. 5 and 6 illustrate a generic car design. However, the shape of the upper shroud part 226b can be formed to correspond to a specific model car which would indicate that not only is the product in the bottle intended for use with a car, but that the source of the product is related to the manufacturer of the indicated car.

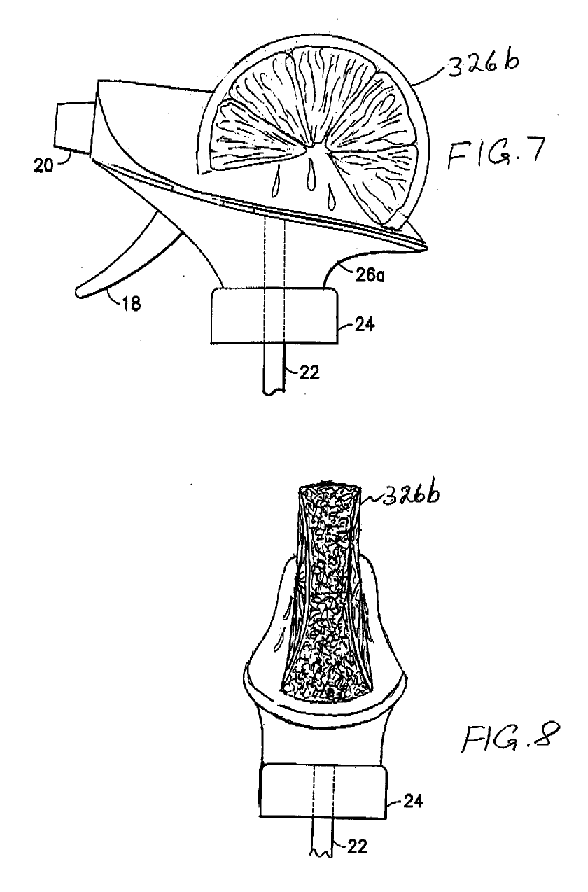

FIGS. 7 and 8 (with like numbers indicating like parts) show an upper shroud part 326b which has a portion which is shaped, textured and colored to show a slice of an orange. Shroud 326b indicates a property of the liquid in the bottle, i.e. its scent. Various citrus fruits such as lemon and lime or other textured fruits such as strawberry can be simulated in this way. In addition to the color and texture, the entire shroud part 326b could be shaped like a portion of the fruit it is simulating. Furthermore, the lower portion 26a could also be shaped, colored, and/or textured to match the top.

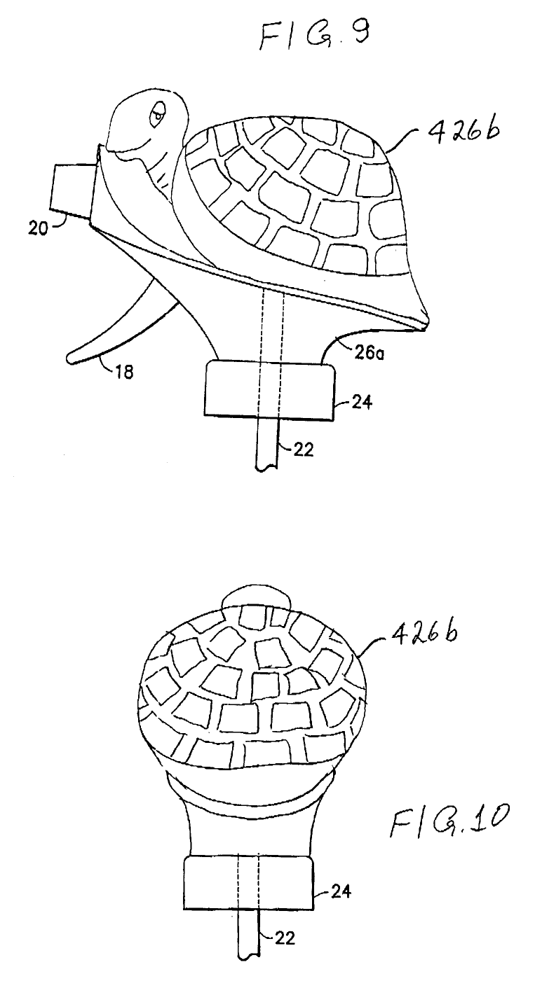

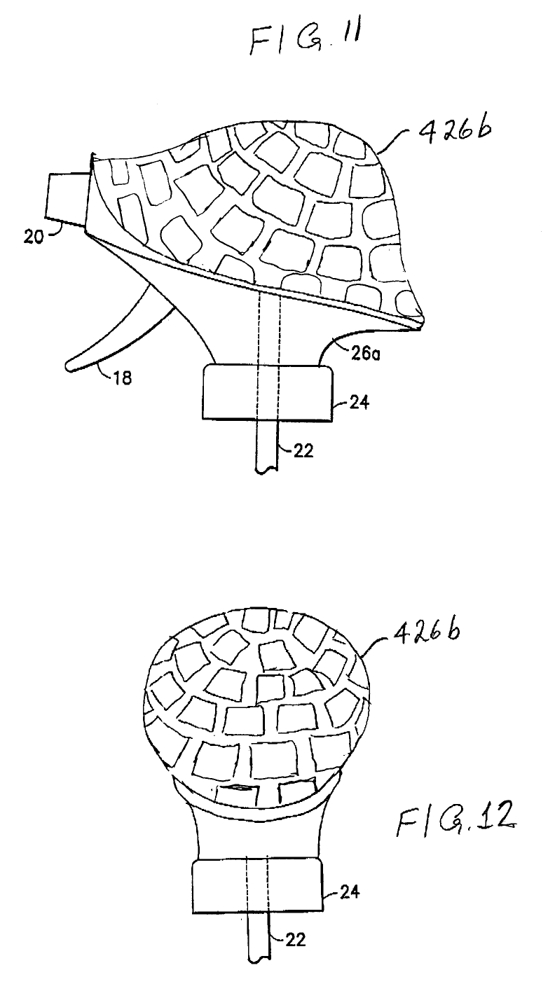

Referring now to FIGS. 9 and 10 (with like numbers indicating like parts), an upper shroud part 426b is shaped, textured and colored to resemble a turtle. Similarly, in FIGS. 11 and 12 (with like numbers indicating like parts), an upper shroud part 526b is shaped, textured and color to resemble a turtle shell. Since a cartoon green turtle is the trademark of Turtle Wax, Inc., the shroud part 426b (or 526b) indicates that the contents of the bottle to which the sprayer is attached are a product of Turtle Wax, Inc. It will be appreciated that the shroud part (or the entire shroud) can be configured with shape(s), color(s), and/or texture(s) to indicate almost any trademark.

There have been described and illustrated herein several embodiments of a trigger sprayer shroud which communicates information and a trigger sprayer incorporating same. While particular embodiments of the invention have been described, it is not intended that the invention be limited thereto, as it is intended that the invention be as broad in scope as the art will allow and that the specification be read likewise. For example, the shroud could be a single piece rather than having upper and lower portions or it could have two side-by-side portions, or it could have more than two portions. In a shroud having upper and lower portions, the lower portion could communicate information in addition to or in lieu of the upper portion. It will be appreciated that other configurations could be used as well. It will therefore be appreciated by those skilled in the art that yet other modifications could be made to the provided invention without deviating from its spirit and scope as claimed.

What is claimed is:

1. A shroud for a trigger sprayer used with a bottled liquid, comprising:
at least a portion of said shroud is formed to have a shape or a texture which communicates information about the nature or source of the liquid.

2. A shroud according to claim 1, further comprising:
said portion has a color which communicates information about the nature of the liquid.

3. A shroud according to claim 2, wherein:
said portion has the texture of a citrus fruit.

4. A shroud according to claim 3, wherein:
said portion is a color selected from the group consisting of orange, yellow, and green.

5. A shroud according to claim 1, wherein:
said portion has the texture indicative of a tire tread.

6. A shroud according to claim 1, wherein:
said portion has a shape indicative of an automobile.

7. A shroud according to claim 1, wherein:
said portion is a three dimensional representation of a trademark.

8. A shroud according to claim 1, wherein:
said shroud has an upper part and a lower part which are separable.

9. A shroud according to claim 8, wherein:
said portion includes substantially all of said upper part.

10. A trigger sprayer, comprising:
a pump having an inlet and an outlet;
a trigger operatively coupled to said pump;
a nozzle coupled to said outlet;
a tube coupled to said inlet;
a bottle coupling surrounding said tube; and
a shroud covering said pump, wherein
at least a portion of said shroud is formed to have a shape or a texture which communicates information about the nature or source of the liquid.

11. A sprayer according to claim 10, further comprising:
said portion has a color which communicates information about the nature of the liquid.

12. A sprayer according to claim 11, wherein:
said portion has the texture of a citrus fruit.

13. A sprayer according to claim 12, wherein:
said portion is a color selected from the group consisting of orange, yellow, and green.

14. A sprayer according to claim 10, wherein:
said portion has the texture indicative of a tire tread.

15. A sprayer according to claim 10, wherein:
said portion has a shape indicative of an automobile.

16. A sprayer according to claim 10, wherein:
said portion is a three dimensional representation of a trademark.

17. A sprayer according to claim 10, wherein:
said shroud has an upper part and a lower part which are separable.

18. A shroud according to claim 17, wherein:
said portion includes substantially all of said upper part.
